(19) United States
(12) Patent Application Publication
(10) Pub. No.: US 2023/0366264 A1
(43) Pub. Date: Nov. 16, 2023

(54) BOX FOR A ROLLING DEVICE

(71) Applicant: MIR SOLUTION S.R.L., Bergamo (IT)

(72) Inventor: Raffaele BELLINI, Bergamo (IT)

(73) Assignee: MIR SOLUTION S.R.L., Bergamo (IT)

(21) Appl. No.: 18/311,905

(22) Filed: May 4, 2023

(30) Foreign Application Priority Data
May 10, 2022 (IT) 102022000009632

(51) Int. Cl. E06B 9/17

(52) U.S. Cl. CPC E06B 9/17023; E06B 9/17076; E06B 2009/17069

(57) ABSTRACT

Box for a rolling device, comprising a box-like body having an inner surface which defines a housing cavity for the rolling device, wherein the box-like body comprises a front opening and a rear opening and a front structural panel fixed to the box-like body for closing the front opening. It includes an insulation system which continuously covers the inner surface of the box-like body and an inner face of the front structural panel. At the front opening, a first tape-like element extends along a continuous closed path around said front opening and, at the rear opening, a second tape-like element which extends along a respective continuous closed path around the rear opening, where the first and the second tape-like element are impermeable to air.

### TECHNICAL FIELD OF THE INVENTION

The present invention relates to a box for a rolling device (e.g., darkening and/or anti-access) and a method for installing the box.

### Prior Art

The use of boxes is known for darkening rolling devices, such as roller shutters and/or awnings, and/or anti-access rolling devices, such as shutters, which typically comprise a box-like body provided with a housing cavity inside which a roller rotatable around its horizontal axis is housed for wind the rolling device. Such boxes are typically installed above the casing (e.g., a window and/or a French window and/or a display case) and at least partially recessed inside the wall masonry at the casing. In use, the rolling device is wound and unwound by means of rotating the roller manually (e.g., by means of a belt) or by driving an electric motor controlled by suitable control means (e.g., a push-button panel or wirelessly).

Typically, an insulation system is provided inside the housing cavity of the box which allows to limit, or avoid, the occurrence of thermal bridges between the housing cavity and outside the box (i.e., zones of direct heat flow depending on the temperature gradient) which can cause the waste of energy and/or the formation of mold or stains.

Documents DE3419206A1 and DE3311668A1 describe a respective box for a rolling device, where the box comprises an insulation system.

### SUMMARY OF THE INVENTION

In the aforesaid scope of boxes for rolling devices comprising an insulation system, the Applicant has made the following considerations and/or identified the following problems.

The Applicant has realized that the known boxes do not ensure an effective and/or reliable airtightness between the internal environment (i.e., the room in which the box is installed) and the environment outside the building. That is, the Applicant has found that, in addition to achieving effective thermal insulation between the internal environment and the housing cavity (which is in air communication with the external environment), it is advantageous to also reduce or eliminate the passage of air between the internal environment and the external environment, in particular through the fluid communication interstices between the internal and external environment which are generated at the box. The Applicant has in particular observed that such fluid communication interstices are present at the two openings of the box itself, one facing the internal environment and closed by a cover, the other facing the masonry and the external environment, and closed by the masonry itself for almost its entire extension, with the exception of a passage slot for the rolling device.

The Applicant has realized that such air passages are disadvantageous as they involve, for example, an undesired heat flow and/or a passage of noise (possibly accentuated by the housing cavity which can act as an echo chamber for sound waves), with consequent discomfort and/or acoustic disturbances for the people inside the room.

The Applicant has thus addressed the problem of creating and installing a box capable of thermally and acoustically insulating the internal environment from the external environment in a reliable and/or lasting manner.

According to the Applicant, the aforesaid problem is solved by a box for a rolling device in accordance with the attached claims and/or having one or more of the following features.

According to an aspect, the invention relates to a box for a rolling device.

Said box comprises a box-like body having an inner surface which defines a housing cavity for the rolling device, wherein the box-like body comprises a front opening and a rear opening.

Said box comprises a front structural panel fixed to the box-like body for (completely) closing said front opening.

Preferably said box comprises an insulation system which (substantially entirely) continuously covers said inner surface of the box-like body and an inner face of said front structural panel.

Preferably said box comprises, at said front opening, a first tape-like element which extends along a continuous closed path around said front opening.

Preferably said box comprises, at said rear opening, a second tape-like element which extends along a respective continuous closed path around said rear opening.

Preferably said first and said second tape-like element are impermeable to air.

The Applicant has realized that the box according to the present invention has high thermal and/or acoustic insulation properties, with such insulation making it also reliable and/or lasting over time.

In fact, the Applicant has realized that the insulation system which continuously covers the inner face of the front panel (facing the housing cavity) and the inner surface of the box-like body (i.e., as a whole, the inner surface of the housing cavity) makes it possible to confer the desired thermal insulation properties. In fact, when the box is installed at the casing, the insulation system is interposed between the housing cavity and the entire surface of the box which is turned towards and/or directly faces (as for example in the case of the front panel) the internal environment (i.e., the room in which the casing is located). It is thereby possible to limit, or avoid, the generation of heat flows between the internal environment (which must be maintained at a predetermined temperature) and the housing cavity (in air communication with the external environment and thus typically at a different temperature from the predetermined temperature of the internal environment).

The Applicant has also realized that the first and the second tape-like element, impermeable to air, which extend along a respective continuous closed path (i.e., without discontinuity) respectively around the front opening and the rear opening of the box-like body contribute to the thermal insulation since, when the box is installed, they ensure airtightness. In particular, the first tape-like element is such as to ensure the airtightness at fluid communication interstices which can possibly form between the box-like body and the front panel (also considering the insulation system), and the second tape-like element is such as to ensure the airtightness at respective fluid communication interstices which, when the box is installed, can form between the box-like body and the masonry or between the box-like body and the casing (including any accessory devices, such as guides for the rolling device).

The tape-like shape of the sealing elements favors both the installation thereof, and the adaptation to the winding of the respective path, with right angles both in the plane of the tape (where the tape is typically composed of two sections) and in planes perpendicular to such a plane of the tape.

The present invention in one or more of the above aspects can have one or more of the following preferred features.

The terms “lower”, “upper” and the like refer to the vertical (geographical) direction in a normal installation condition of the box.

Typically said front opening and said rear opening are located at opposite ends of the housing cavity. In fact, the rear opening allows the passage of the rolling device, while the front opening (closed by the front panel) allows the internal inspection of the box from the environment inside the building.

In an embodiment the front opening and the front panel (extend on a horizontal plane and) are arranged below the box-like body (and are proximal to a front end of the box). That is, the inspection occurs from below the box.

In a preferred embodiment the front opening and the front panel extend on a vertical plane. That is, the inspection occurs from the front of the box.

Preferably said box-like body comprises an upper structural panel, a lower structural panel and two side structural panels. Typically, each of the structural panels (the front, upper, lower and side structural panels), as well as each of the insulating panels described below, comprises a respective main extension plane and a respective inner (facing the housing cavity) and outer face opposite each other and parallel to the respective main extension plane of the panel. Furthermore, each of the panels has a thickness perpendicular to the respective main extension plane, with said respective thickness defining a respective edge face of the panel. Depending on the context, a reference to the panel, in particular to the orientation in the space of the panel, can imply a reference to the respective main extension plane.

Preferably the upper structural panel is parallel to the lower structural panel and is perpendicular to the two side structural panels, the latter being parallel to each other. Thereby, the box-like body is made in a rational manner.

Preferably said front structural panel and said box-like body (preferably each of said upper, lower and side structural panels) are made of wood. Exemplarily, each structural panel is made of solid wood. The Applicant has observed that wood has high thermal insulation properties, as well as being easily available on the market, economical, easily processed and aesthetically pleasing.

Preferably said front structural panel, and more preferably each of said upper structural panel, said lower structural panel and said two side structural panels, has a rectangular plan (i.e., the respective inner and outer faces are rectangular in shape). Thereby, the panels have a simple and rational shape (e.g., parallelepiped).

Preferably, with reference to a direction perpendicular to said front structural panel, said upper structural panel has a greater extension (i.e., a dimension) than an extension of the lower structural panel. That is, along the direction perpendicular to the front panel, the upper panel is longer than the lower panel. Thereby, the rear opening comprises a slot below for the passage of the rolling device which always remains open even when the box is installed.

Preferably said upper structural panel, said lower structural panel and said two side structural panels are perpendicular to said front structural panel (when the latter is fixed to the box-like body). Preferably said upper structural panel, said lower structural panel and said two side structural panels protrude from said inner face (preferably from a respective peripheral side of the inner face) of said front structural panel (when the latter is fixed to the box-like body). Thereby, the front panel closes the front opening in a simple and effective manner.

Preferably said rear opening is (totally) free when said box is not installed. That is, the box does not comprise any structural panel (or other element) fixed to the box-like body for closing (in part) the rear opening. It is thereby possible to limit the overall dimensions of the box, in particular when the latter is installed. In fact, the rear opening can be advantageously closed (with the exception of the slot for the passage of the rolling device) by the wall to which the box is installed.

In an alternative embodiment, said box comprises a rear structural panel fixed to the box-like body for closing said rear opening (with the exception of the slot for the passage of the rolling device).

Preferably said insulation system is in a material having thermal conductivity (λ) less than or equal to 0.20 W/(m*K), more preferably less than or equal to 0.15 W/(m*K), even more preferably less than or equal to 0.10 W/(m*K). It is thereby possible to provide the desired thermal insulation properties of the box.

Preferably said insulation system is made of (at least) one material chosen from: sintered expanded polystyrene (EPS) reinforced with graphite, extruded expanded polystyrene (XPS), thermoplastic polyurethane (PUR), (silica) aerogel, polyisocyanurate (PIR), wood fiber, and combinations thereof. The materials listed above are capable of optimizing the thermal insulation properties (as such materials typically have thermal conductivity less than 0.10 W/(m*K)) and at the same time are easily available on the market and/or have low costs.

Preferably said insulation system comprises a first portion which at least partially continuously covers said inner face of the front structural panel and a second portion (distinct from said first portion) which at least partially continuously covers said inner surface of the box-like body. It is thereby possible to separate the front panel, together with the first portion of the insulation system, from the box-like body (and from the second portion of the insulation system).

Preferably said first portion of the insulation system comprises (more preferably consists of) a first insulating panel fixed (e.g., glued) at said inner face of the front structural panel. Preferably said second portion of the insulation system comprises (more preferably consists of) a second, a third, a fourth and a fifth insulating panel fixed (e.g., glued) at an inner face of said upper structural panel, said lower structural panel and said two side structural panels, respectively. It is thereby possible to simply and effectively cover the inner faces of the structural panels, to provide the desired thermal insulation properties.

Preferably each insulating panel has a respective thickness perpendicular to the respective structural panel (i.e., the structural panel it covers), said respective thickness defining a respective edge face of the insulating panel. Typically, each insulating panel extends parallel to the respective structural panel (e.g., parallel to the inner face).

Preferably said first tape-like element is interposed in contact (more preferably compressed) between said first portion and said second portion of the insulation system.

Preferably said first tape-like element is interposed in contact (more preferably compressed) between said first insulating panel (preferably an inner face of the first insulating panel, more preferably in a peripheral position of the inner face of the first insulating panel) on one side, and the second, third, fourth and fifth insulating panel (preferably a respective edge face of the second, third, fourth and fifth insulating panel proximal to the front opening) on another side. It is thereby possible to obtain the airtightness in a position proximal to the housing cavity.

Preferably said first tape-like element is stably fixed (e.g., glued) to one (and more preferably only one) between said first portion and said second portion of the insulation system, more preferably it is stably fixed (only) to said second portion. Preferably said first tape-like element is removably in contact with another between said first portion and said second portion of the insulation system, more preferably with said first portion. That is, it is possible to separate the first tape-like element from one of the two portions (preferably the first) in a simple, non-destructive and repeatable manner. It is thereby possible to remove the front panel without damaging the first tape-like element and/or the insulation system.

Preferably a first part of said second tape-like element extends in contact with (more preferably is stably fixed, e.g., glued to) said insulation system, more preferably with said second portion of the insulation system, on the opposite side of the insulation system with respect to said first tape-like element. That is, the first part of the second tape-like element contacts (is fixed to) the insulation system from the part facing the rear opening. It is thereby possible to ensure airtightness at the rear opening in a simple and effective manner.

Preferably the first part of the second tape-like element extends in contact (at least) with (more preferably is stably fixed, e.g., glued to) a respective edge face of the second, fourth and fifth insulating panel proximal to said rear opening (and preferably also with an edge face and an outer face of the lower structural panel). Thereby, the airtightness on three sides of the rear opening is ensured.

Preferably a second part of said second tape-like element extends in contact with (more preferably is stably fixed, e.g., glued to) an outer surface (preferably a lower face) of said box-like body (more preferably an outer face of said lower structural panel, i.e., the face of the lower panel opposite the housing cavity). Thereby, the path of the second insulating element, despite being closed, does not interfere with the slot for the passage of the rolling device.

Preferably said first and/or said second tape-like element are positioned on a respective edge face (of a respective panel) of the insulating system in a position proximal to the housing cavity. Thereby, the seal is obtained in a position as far as possible from the internal environment.

Preferably said first and/or said second tape-like element is in expanded polymeric foam (preferably polyurethane), i.e., a foam comprising one or more foaming agents, more preferably open-celled. The Applicant has realized that such foams are well suited to provide the desired airtight properties and also, in particular in the case of polyurethane foam, allows to limit, or avoid, the infiltrations of water and/or water vapor which can cause the formation of stains and/or mold on the box and/or on the wall of the building.

Preferably said first and/or said second tape-like element are obtained from a tape.

Preferably the tape has one (and only one) face provided with an adhesive layer.

Preferably said tape has a plan width greater than or equal to 3 mm, more preferably greater than or equal to 5 mm, even more preferably greater than or equal to 10 mm, and/or less than or equal to 60 mm, more preferably less than or equal to 55 mm, even more preferably less than or equal to 50 mm. Thereby the two tape-like elements have a width such as to allow a simple and/or versatile application to the box, while ensuring the desired airtightness.

Preferably said first and/or said second tape-like element comprises a (respective) plurality (e.g., from three to twenty, preferably from four to ten) of tape tracts distinct from each other and arranged in series to form the respective continuous closed path. Preferably an end portion of each tape tract of the respective series overlays a respective end portion of a contiguous tape tract of the respective series. It is thereby possible to achieve the airtightness at marked changes in the direction of the path of the tape-like element, such as at the edges of the front and rear openings.

Preferably said first and/or said second tape-like element (e.g., said tape) is/are self-expanding, i.e., they are deformable and capable, once compressed and subsequently freed of the compressive force, of reassuming the original shape (in particular in the thickness direction, i.e., along a direction perpendicular to a main extension plane of the tape, they tend to reassume the maximum natural thickness, see below). Thereby, once the box is assembled and installed, after a sufficiently long time (e.g., greater than 24 hours) the tape-like elements, initially compressed to a reduced thickness, expand to fully occupy the interstices in which they are positioned (also following subsequent structural adjustments and/or deformations of the structure of the box and/or the wall to which the box is installed). The Applicant considers it advantageous that the first and the second tape-like element (in particular by virtue of the expanded polymeric foam) have a viscoelastic behavior in the direction of the thickness.

Preferably said tape has a minimum natural thickness greater than or equal to 1 mm, more preferably greater than or equal to 2 mm, and/or less than or equal to 5 mm, more preferably less than or equal to 4 mm. “Minimum natural” thickness is intended as the minimum thickness which the tape can assume (when subjected to a reasonable compressive force).

Preferably said tape has a minimum natural thickness greater than or equal to 5 mm, more preferably greater than or equal to 10 mm, even more preferably greater than or equal to 20 mm, and/or less than or equal to 50 mm, more preferably less than or equal to 40 mm. “Maximum natural” thickness is intended as the maximum thickness which the tape assumes when free from compressive forces for a sufficiently long time (e.g., 24 hours).

Preferably a ratio between said maximum natural thickness and said minimum natural thickness is greater than or equal to 3, more preferably greater than or equal to 4, even more preferably greater than or equal to 5, and/or less than or equal to 20, more preferably less than or equal to 15.

Preferably a ratio between a working thickness of said tape and said minimum natural thickness is greater than or equal to 1.2, more preferably greater than or equal to 1.5, even more preferably greater than or equal to 2, and/or less than or equal to 10, more preferably less than or equal to 5. “Working” thickness is intended as the thickness which the tape assumes when subjected to compressive forces during use, i.e., when the box is installed, after a sufficiently long time (e.g., 24 hours). Thereby, during use, the first and the second tape-like element are in an intermediate compression condition between the maximum and the minimum, so as to effectively ensure airtightness.

In an embodiment, the invention relates to the box according to any embodiment of the present invention installed at a casing of a building equipped with the rolling device.

According to an aspect, the invention relates to a method for installing the box according to any embodiment of the present invention, said method comprising:
producing (preferably prefabricating) the box;
fixing said box at a casing of a building equipped with the rolling device, with said rear opening facing an inner surface of a wall of the building.

Preferably a first part of the second tape-like element is (at least in part) interposed (in contact and compressed) between (said second portion of) said insulation system (preferably said respective edge face of the second, fourth and fifth insulating panel) and said inner surface of the wall.

Preferably a second part of the second tape-like element is interposed (in contact and compressed) between an outer surface (preferably a lower face) of the box-like body and an abutment surface defined by at least one of: said wall and/or said casing and/or an accessory device to the casing (e.g., a guide for the rolling device).

### BRIEF DESCRIPTION OF THE FIGURES

FIG. 1 schematically shows a perspective view from behind and from above of a box for a rolling device according to an embodiment of the present invention;

FIG. 2 schematically shows a perspective view from behind and from below of the box of FIG. 1;

FIG. 3 schematically shows a perspective view from the front and from above of the box of FIG. 1, with the front panel decoupled from the box-like body;

FIGS. 4a, 4b and 4c show schematically and in lateral section a portion of tape in three different compression conditions to which three different tape thicknesses correspond;

FIG. 5 schematically and partially shows a section of the box of FIG. 1 installed at a casing.

### DETAILED DESCRIPTION OF THE INVENTION

The features and advantages of the present invention will be further clarified by the following detailed description of some embodiments of the present invention, presented by way of non-limiting example, with reference to the attached figures.

It should be noted that the figures are not to scale and are for illustrative purposes only.

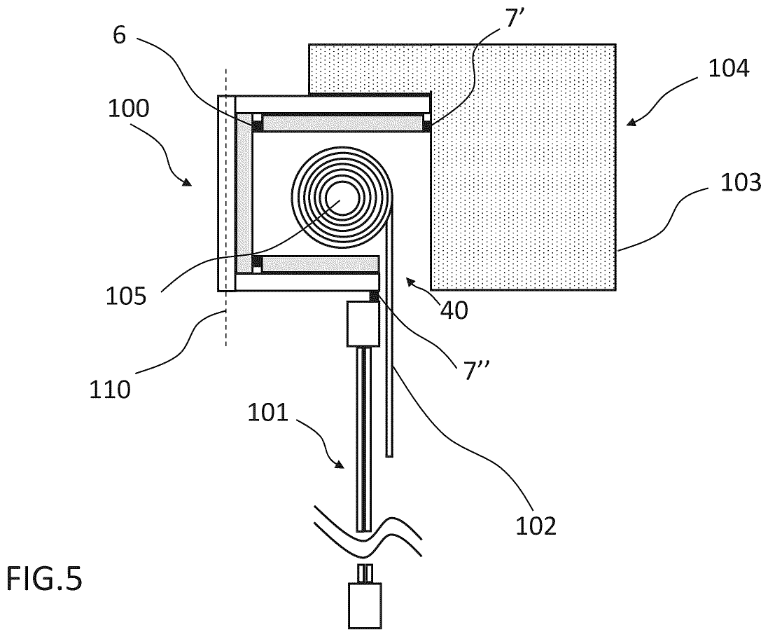

In the figures, reference numeral 100 denotes a box for a rolling device 102, such as a shutter, which, as schematically shown in FIG. 5, can be installed above a casing 101, such as a window or a French window. Typically, such a box 100 is at least partly recessed inside a masonry 103 of a wall 104 of a building (not shown) in which the casing 101 is present.

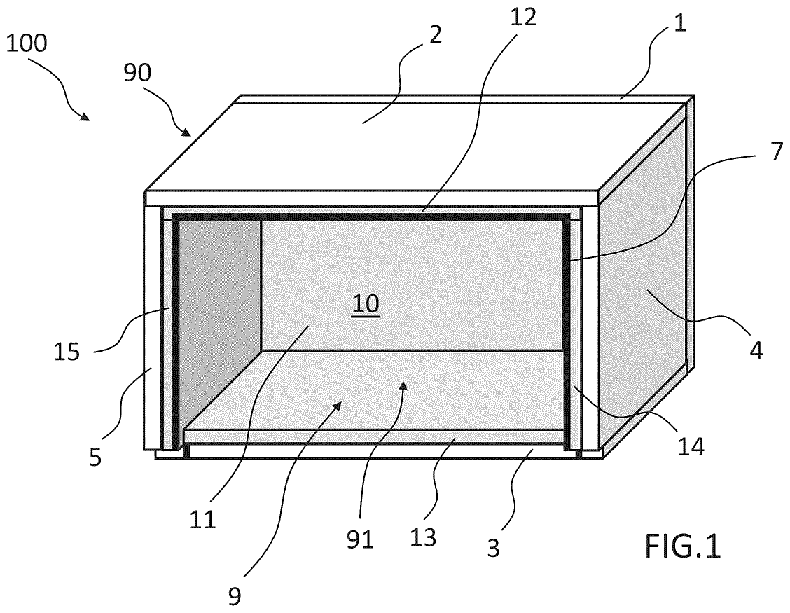

With particular reference to FIGS. 1-3, the structure of the box 100 is described below. Hereinafter, the terms “front/rear”, and “upper/lower” refer respectively to the horizontal direction and the vertical direction in a normal installation condition of the box 100. Furthermore, the term front refers to the side proximal to the interior environment of the building.

The box 100 comprises a box-like body 90 which defines a housing cavity 10 of at least part of the rolling device 102 and typically also of the rotating roller 105 on which the rolling device 102 is wound.

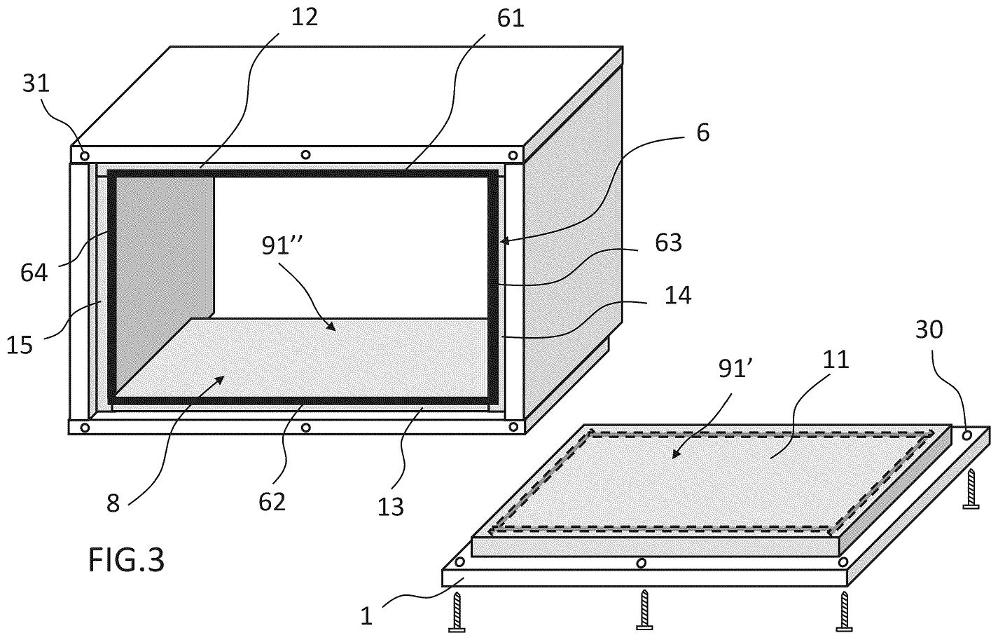

The box-like body 90 comprises a front opening 8 (shown in FIG. 3) and a rear opening 9, for example at opposite ends of the housing cavity 10.

Exemplarily the box-like body 90 comprises an upper structural panel 2, a lower structural panel 3 and two side structural panels 4 and 5 (hereinafter the term “structural” may be omitted for the sake of simplicity).

The box 100 also comprises a front structural panel 1 fixed (for example removably by suitable mechanical fixing means, such as threaded screws and/or bolts) to the box-like body 90 to completely close the front opening 8. For example, as schematically shown in FIG. 3, the mechanical fixing means is positioned inside suitable seats 30 and 31 obtained respectively in the front panel 1 and in the box-like body 90 around the front opening 8.

In the embodiment shown in the figures, the front opening 8 and the front panel 1 extend on a vertical plane and are located at a front face of the box 100, facing the internal environment of the building (i.e., the room in which the box is installed).

In an embodiment not shown, the front opening and the front panel extend on a horizontal plane and are arranged below the box-like body, typically in a position proximal to the front face of the box. That is, the front opening is obtained at a front portion of the lower panel proximal to the environment inside the building, where the front panel, when coupled to the box-like body, is complementary to the lower panel to form a lower face of the box. In such an embodiment, the box-like body also comprises a further structural panel permanently fixed to the upper and side panels to form the front face of the box.

Each of the structural panels 1-5 (and of the insulating panels 11-15, below) has a respective main extension plane (shown exemplarily in FIG. 5 for the front panel with the dashed line 110 halfway through the panel), i.e., the plane defined by the two larger dimensions of each panel (typically, length and width). Each panel typically has a lesser thickness (i.e., the dimension perpendicular to the respective main extension plane, e.g., at least five times or at least ten times less) than both the respective length and width. Furthermore, the thickness of each panel defines a respective edge face of the panel (i.e., the four side faces of each panel). Each panel also has a respective inner face (i.e., the face facing the housing cavity) and a respective outer face, opposite each other and parallel to the respective main extension plane of the panel.

Exemplarily the panels have a rectangular plan shape (and exemplarily also in orthogonal section to the main extension plane of the panel).

Exemplarily the structural panels 1-5 are made of solid wood, for example maple, chestnut or beech wood.

As usual, the box-like body 90 has the shape of a parallelepiped, with two open faces at the front 8 and rear 9 openings. The present invention contemplates any shape and structure of the box-like body and front panel.

The box 100 has a slot 40 below and behind (indicated in FIG. 5, and shown in an accentuated manner) for the passage of the rolling device 102. To this end, with reference to a direction perpendicular to the main extension plane of the front panel 1, the upper panel 2 is longer than the lower panel 3.

The box 100 further comprises an insulation system 91, for example made entirely of extruded expanded polystyrene (XPS, with thermal conductivity equal to about 0.031 W/(m*K)), which entirely and continuously covers the inner surface which defines the housing cavity 10.

Exemplarily the insulation system 91 comprises a first portion 91′ which consists exemplarily of a first insulating panel 11 stably fixed (e.g., glued) at the inner face of the front panel 1 and which continuously covers the inner face of the front panel 1, with the exception of the peripheral edge portion of the inner face which, when the front panel 1 is fixed to the box-like body 90, contacts the edge faces of the panels 2-5.

Exemplarily, the insulation system 91 comprises a second portion 91″ distinct from the first portion 91′, which exemplarily consists of a second 12, a third 13, a fourth 14 and a fifth insulating panel 15 stably fixed (e.g., glued) at the inner faces of the upper 2, lower 3 and side panels 4 and 5, respectively. The second portion 91″ continuously covers the entire inner surface of the box-like body, with the exception of the portions engaged by the first insulating panel 11.

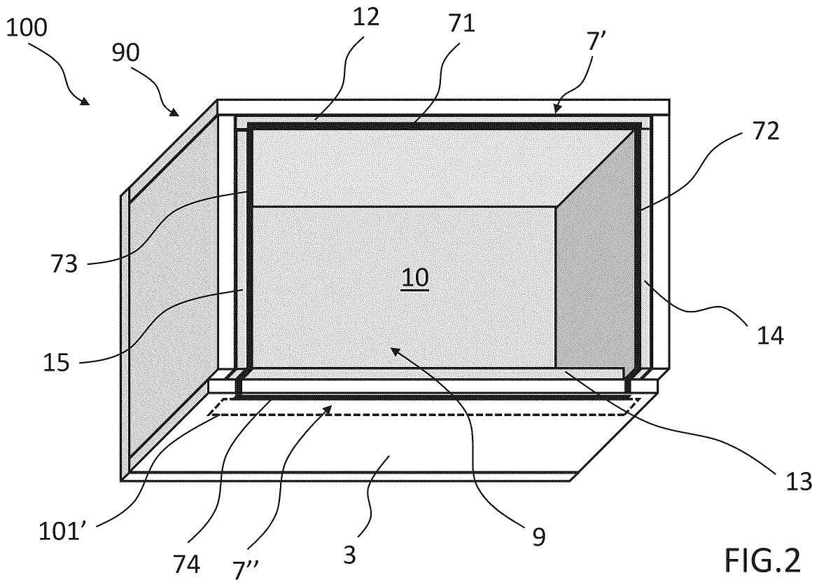

The box 100 comprises, proximal to the front opening 8, a first tape-like element 6 (visible in FIG. 3) and, near the rear opening 9, a second tape-like element 7 (visible in FIGS. 1-2). Each tape-like element 6, 7 is exemplarily made from a respective plurality of tape tracts distinct from each other and arranged in series to form a respective continuous closed path around the front opening 8 and the rear opening 9, respectively. Exemplarily, within the same series, the contiguous tape tracts overlay each other at end portions (so as to increase airtightness in the critical areas).

Exemplarily, the tape is made of open-celled expanded polyurethane foam with only one adhesive side, such as the tape marketed by Wurth Italia Srl under the trade name VKP® PIU.

Exemplarily each tape tract has a plan width equal to about 15 mm.

With reference to FIG. 3, the first tape-like element 6 exemplarily comprises four tape tracts 61-64, respectively glued only to a respective edge face of the insulating panels 12-15 proximal to the front opening 8. When the front panel 1 is fixed to the box-like body 90, the four tape tracts 61-64 are compressed against a peripheral edge portion of the inner face of the first insulating panel 11 (as shown in FIG. 3 by the dashed tape footprint on the first insulating panel 11). Typically, the four tape tracts 61-64 do not have adhesive facing the first insulating panel 11, so as to favor the reversible removal of the front panel 1 and the first insulating panel 11 (glued to the front panel 1) to access the housing cavity 10 (for example to clean it). Alternatively, the adhesive layer of the tape tracts 61-64 can be on the face facing the first insulating panel 11 and not on the face facing the edge faces of the insulating panels 12-15.

With reference to FIG. 2, also the second tape-like element 7 can exemplarily comprise four tape tracts 71-74.

Exemplarily, the second tape-like element 7 comprises a first part 7′ consisting of three tape tracts 71-73. Such a first part 7′ is glued by means of adhesive mainly to the second portion 91″ of the insulation system 91 proximal to the rear opening 9. In particular, a first tape tract 71 is glued to the edge face of the second insulating panel 12 proximal to the rear opening 9, and a second tape tract 72 is glued in part to the edge face of the fourth insulating panel 14 proximal to the rear opening 9, in part to the lower edge face of the fourth insulating panel 14, in a further part to the edge face of the lower structural panel 3 proximal to the rear opening 9 and in a last part (preferably overlaid on the end of the fourth tape tract 74) to the outer face of the lower panel 3. Considerations similar to those for the second tape tract 72 also apply for the third tape tract 73.

Exemplarily, the second tape-like element 7 comprises a second part 7″ consisting exemplarily of a fourth tape tract 74 glued to the outer face of the lower panel 3.

When the box 100 is installed above the casing 101, the second tape-like element 7 is trapped between the aforesaid elements of the box and some outer abutment surfaces of the box itself. For example:
for the first tape tract 71 an inner surface of the wall 104,
for the second tape tract 72 (and similarly for the third tape tract 73) the inner surface of the wall 104 for the part of the second tract 72 which is fixed to the edge face of the fourth insulating panel 14, an accessory device to the casing (not shown, for example a guide for the rolling device 102) for the part of the second tract 72 which is fixed to the lower edge face of the fourth insulating panel 14 and to the edge face of the lower panel 3, and the casing 101 for the part of the second tract 72 which is fixed to the outer face of the lower panel 3,
for the fourth tape tract 74 the casing 101, as schematically shown in FIG. 2 by the footprint 101′ of the casing 101 on the outer face of the lower panel 3.

Exemplarily, as shown in the figures, the tape tracts 61-64 of the first tape-like element 6 and the tape tracts 71-74 of the second tape-like element 7 are positioned on an edge of the respective edge face of the insulating and/or structural panel so as to be in a position proximal (adjacent) to the housing cavity 10. Thereby, airtightness is achieved in a position as proximal as possible to the housing cavity, and therefore in a position distal from the environment inside the building.

The Applicant has realized that the box according to the present invention is also suitable for being designed in a versatile manner to comply with the needs of the work site (e.g., type of casing and/or size of the casing) and/or is suitable for being made in different sizes and/or different ratios of its components.

Furthermore, according to the Applicant the box according to the present invention lends itself to being produced and transported as a prefabricated element, allowing to simplify and/or speed up the box installation operations. In fact, the Applicant has observed that it may be advantageous to provide the above-described box at the work site, with the possible exception of the one or more tape tracts which form the second part 7″ of the second tape-like element 7. In fact, the Applicant has observed that the second part 7″ of the second tape-like element 7 can be arranged in different shapes depending on the morphology and/or the shape of the work site (e.g., size of the casing and/or of the guides for the rolling device and/or of the dimensions of the box following, for example, the aesthetic needs/requests of the customer).

Once the box 100 is produced and sent to the work site, the box 100 is fixed by suitable mechanical means above the casing 101 of the building equipped with the rolling device 102, with the rear opening 9 facing the inner surface of the wall 104 of the building and the slot 40 free.

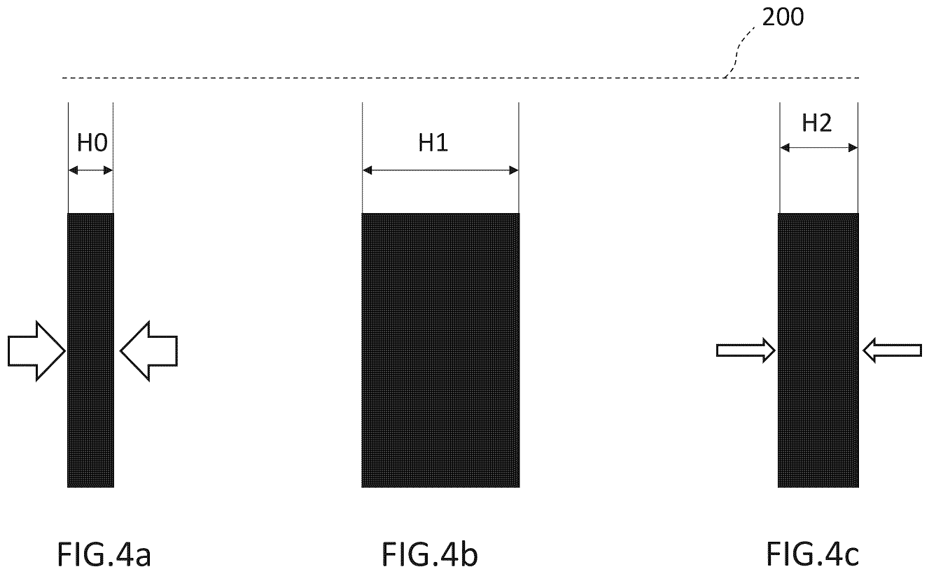

With reference to FIGS. 4a-c, the viscoelastic compression behavior of the tape forming the tape-like elements 6 and 7 is now described. In particular, the tape has a thickness H0, H1, H2, taken along a direction perpendicular 200 to a main extension plane of the tape (typically parallel to the surface on which the tape is applied) variable as a function of a degree of compression of the tape along said direction 200.

The tape assumes a minimum natural thickness H0, i.e., the minimum thickness which the tape can assume when subjected to a sufficiently high compressive force (schematically depicted by the double arrow in FIG. 4a) (and typically greater than that which it undergoes during use, i.e., when the box 100 is installed at the casing 101). For example, the minimum natural thickness H0 of the tape is equal to about 3 mm.

The tape assumes a maximum natural thickness H1, i.e., the maximum thickness which the tape assumes when free from compressive forces for a sufficiently long time, for example for at least 24 hours. For example, the maximum natural thickness H1 of the tape is equal to about 20 mm.

During normal use, the tape is compressed (double arrow in FIG. 4c) and trapped between two abutment surfaces, so as to assume an intermediate working thickness between the minimum and maximum natural thickness, for example equal to about 5 mm. By virtue of the tendency to return to its maximum natural thickness, after a sufficiently long time, for example more than 24 hours, the tape tends to expand, occupying all the interstices and/or empty spaces formed between the two abutment surfaces.

What is claimed is:

1. A box for a rolling device, comprising:
a box-like body having an inner surface which defines a housing cavity for the rolling device, wherein the box-like body comprises a front opening and a rear opening;
a front structural panel fixed to the box-like body for closing said front opening;
an insulation system which continuously covers said inner surface of the box-like body and an inner face of said front structural panel;
at said front opening, a first tape-like element which extends along a continuous closed path around said front opening;
at said rear opening, a second tape-like element which extends along a respective continuous closed path around said rear opening,
wherein said first and said second tape-like element are impermeable to air.

2. The box according to claim 1, wherein said insulation system comprises:
a first portion comprising a first insulating panel fixed at said inner face of the front structural panel which continuously covers at least partially said inner face of the front structural panel; and
a second portion which continuously covers at least partially said inner surface of the box-like body.

3. The box according to claim 2, wherein said front structural panel and said box-like body are made of wood, wherein said box-like body comprises an upper structural panel, a lower structural panel and two side structural panels, wherein said front structural panel, and each of said upper structural panel, said lower structural panel and said two side structural panels, has a rectangular plan, wherein the upper structural panel is parallel to the lower structural panel and is perpendicular to the two side structural panels, the latter being parallel to each other, wherein, with reference to a direction perpendicular to said front structural panel, said upper structural panel has a greater extension than an extension of the lower structural panel, and wherein said upper structural panel, said lower structural panel and said two side structural panels protrude from said inner face of said front structural panel, wherein said second portion comprises a second, a third, a fourth and a fifth insulating panel fixed at an inner face of respectively said upper structural panel, lower structural panel and two side structural panels.

4. The box according to claim 3, wherein said first tape-like element is firmly fixed to said second portion of the insulation system and removably in contact with said first portion of the insulation system, wherein a first part of said second tape-like element extends in contact with said second portion of the insulation system on the opposite side of the insulation system with respect to said first tape-like element, and wherein a second part of said second tape-like element extends in contact with an outer surface of said box-like body.

5. The box according to claim 4, wherein each insulating panel has a respective thickness perpendicular to the respective structural panel, said respective thickness defining a respective edge face of the insulating panel, wherein said first tape-like element is interposed in contact between said first insulating panel on one side, and the second, third, fourth and fifth insulating panel on the other side, wherein said first part of the second tape-like element extends in contact with a respective edge face of the second, fourth and fifth insulating panel proximal to said rear opening, and wherein said second part of said second tape-like element extends in contact with an outer face of said lower structural panel.

6. The box according to claim 1, where said insulation system is made of a material selected from: sintered expanded polystyrene (EPS) reinforced with graphite, extruded expanded polystyrene (XPS), thermoplastic polyurethane (PUR), silica aerogel, polyisocyanurate (PIR), wood fiber, and combinations thereof, and wherein said first and said second tape-like element are made of expanded polymeric foam.

7. The box according to claim 1, wherein said first and said second tape-like element are made by a tape having a plan width greater than or equal to 3 mm and less than or equal to 60 mm, wherein said tape has a minimum natural thickness (H0) greater than or equal to 1 mm and less than or equal to 5 mm, wherein said tape has a maximum natural thickness (H1) greater than or equal to 5 mm and less than or equal to 50 mm, and wherein a ratio between said maximum natural thickness (H1) and said minimum natural thickness (H0) is greater than or equal to 3 and less than or equal to 20.

8. The box according to claim 1, wherein said first and said second tape-like element are self-expanding, wherein said first (6) and said second tape-like element comprise a respective plurality of tape tracts distinct from each other and arranged in series to form the respective continuous closed path, and wherein an end portion of each tape tract of the respective series overlays a respective end portion of a contiguous tape tract of the respective series.

9. A method for installing a box for a rolling device, said method comprising:
producing the box comprising:
a box-like body having an inner surface which defines a housing cavity for the rolling device, wherein the box-like body comprises a front opening and a rear opening;
a front structural panel fixed to the box-like body for closing said front opening;
an insulation system which continuously covers said inner surface of the box-like body and an inner face of said front structural panel;
at said front opening, a first tape-like element which extends along a continuous closed path around said front opening;
at said rear opening, a second tape-like element which extends along a respective continuous closed path around said rear opening,
wherein said first and said second tape-like element are impermeable to air;
fixing said box at a casing of a building equipped with the rolling device, with said rear opening facing an inner surface of a wall of the building.

10. The method according to claim 9, wherein a first part of the second tape-like element is interposed between said insulation system and said inner surface of the wall, wherein a second part of the second tape-like element is interposed between an outer surface of the box-like body and an abutment surface defined by at least one of: said wall, said casing and an accessory device to the casing, and wherein a ratio between a working thickness (H2) and a minimum natural thickness (H0) of said first and said second tape-like element is greater than or equal to 1.5 and less than or equal to 10.
